SEQUENCE LISTING (1 sequence)

SEQ ID NO: 1 - protein, 269 aa, Rhizopus oryzae
SDGGKVVAATTAQIQEFTKYAGIAATAYCRSVVPGNKWDCVQCQKWVPDGKIITTFTSLLSDTNGYVLRSDKQKTIYLVFRGTNSFRSAITDIVFNFSDYKPVKGAKVHAGFLSSYEQVVNDYFPVVQEQLTANPTYKVIVTGHSLGGAQALLAGMDLYQREPRLSPKNLSIFTVGGPRVGNPTFAYYVESTGIPFQRTVHKRDIVPHVPPQSFGFLHPGVESWIKSGTSNVQICTSEIETKDCSNSIVPFTSLLDHLSYFDINEGSCL

(19) United States
(12) Patent Application Publication
(10) Pub. No.: US 2013/0266552 A1
(43) Pub. Date: Oct. 10, 2013

(54) LIQUID SURFACTANT PREPARATION CONTAINING LIPASE AND PHOSPHONATE

(71) Applicant: Henkel AG & Co., KGaA, Duesseldorf (DE)

(72) Inventors: Karl-Heinz Maurer, Erkrath (DE); Timothy O'Connell, Duesseldorf (DE); Petra Siegert, Haan (DE); Thomas Weber, Dormagen (DE); Susanne Tondera, Duesseldorf (DE); Hendrik Hellmuth, Duesseldorf (DE)

(21) Appl. No.: 13/922,509

(22) Filed: Jun. 20, 2013

Related U.S. Application Data
(63) Continuation of application No. PCT/EP2011/072513, filed on Dec. 13, 2011.

(30) Foreign Application Priority Data
Dec. 21, 2010 (DE) 10 2010 063 743.2

(51) Int. Cl. C11D 3/386; C11D 1/78

(52) U.S. Cl. CPC C11D 3/38627; C11D 1/78
USPC 424/94.2; 510/392; 424/94.6; 435/263; 435/264; 510/375

(57) ABSTRACT

A liquid surfactant preparation comprises a phosphonate and has an advantageous lipolytic activity. This is achieved by using a lipase that is naturally present in a microorganism, the microorganism being Rhizopus oryzae or Mucor javanicus.

### FIELD OF THE INVENTION

The present invention generally relates to enzyme-containing liquid surfactant preparations, such as are used for example for washing, cleaning or disinfecting, and more particularly relates to enzyme-containing liquid surfactant preparations that comprise defined lipases in combination with a phosphonate, and further proposes uses and methods, in which such preparations are used. The invention further relates to uses of defined lipases in liquid surfactant preparations that comprise a phosphonate.

### BACKGROUND OF THE INVENTION

Phosphonates are often included in surfactant preparations, in particular in modern liquid washing agents, but also in cleaning agents or disinfectants. They are added for example as complexants, for preventing precipitations or as stabilizers for bleaching agents. As complexants, for example, they act as water softeners. They can encase cations such as Ca²⁺ in the solution and thereby modify the chemical behavior of the cation. In the case of calcium, the property of forming water hardness disappears. Other cations can also be complexed and thus be protected from chemical reactions. Furthermore, they can play a part as corrosion inhibitors or act as stabilizers for peroxides, in particular in bleaching agents.

Lipases are increasingly incorporated in surfactant preparations, in particular in washing or cleaning agents. A lipase is an enzyme that catalyzes the hydrolysis of ester bonds in lipid substrates, particularly in fats and oils. Therefore, lipases illustrate a group of the esterases. Generally speaking, lipases are versatile enzymes that accept a plurality of substrates, for example aliphatic, alicyclic, bicyclic and aromatic esters, thioesters and activated amines. Lipases are effective against fat residues in the wash by catalyzing their hydrolysis (lipolysis). Lipases with a broad substrate spectrum are particularly used where inhomogeneous raw materials or mixed substrates have to be transformed, thus for example in washing and cleaning agents, because soils can consist of different types of fats and oils. The lipases incorporated in the washing or cleaning agents from the prior art are usually of microbiological origin and generally originate from bacteria or fungi, for example from the genera Bacillus, Pseudomonas, Acinetobacter, Micrococcus, Humicola, Trichoderma or Trichosporon. Lipases are usually produced by suitable microorganisms following biotechnological processes known per se, for example by transgenic expression hosts of the genera Bacillus or by filamentous fungi.

A lipase from Pseudomonas sp. ATCC 21808 provided for washing and cleaning agents is disclosed, for example, in the European patent application EP 443063, but not explicitly for use in a phosphonate-containing liquid formulation. A lipase from Rhizopus oryzae is disclosed in the Japanese patent application JP 1225490. However, from this document, no practical liquid surfactant preparation resulted which imperatively comprises a phosphonate in combination with a lipase from Rhizopus oryzae.

Generally, only selected lipases are actually suitable for use in liquid surfactant preparations. Many lipases do not show adequate catalytic efficiency or stability in such preparations. This problem is even more serious in phosphonate-containing liquid surfactant preparations, due for example to the complexing properties of the phosphonate or due to unfavorable interactions between the phosphonate and the lipase.

Consequently, lipase-containing liquid surfactant preparations of the prior art, in particular those with phosphonates, often have the disadvantage of an insufficient lipolytic activity, and the surfactant preparation therefore does not have an optimal cleaning power on lipase-sensitive soils.

It is therefore desirable to overcome the cited disadvantage on the provision of a phosphonate-containing liquid surfactant preparation that possesses an advantageous lipolytic activity.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A liquid surfactant preparation containing a phosphonate and a lipase that exists naturally in a microorganism, wherein the microorganism is Rhizopus oryzae or Mucor javanicus.

A method, in particular a washing, cleaning or disinfection method, in which a washing liquor that contains a phosphonate and a lipase that exists naturally in a microorganism, is brought into contact with a lipase-sensitive soil or a germ on a fabric or on a hard surface, wherein said microorganism is Rhizopus oryzae or Mucor javanicus.

Use of a lipase that exists naturally in a microorganism, wherein the microorganism is Rhizopus oryzae or Mucor javanicus, so as to provide a lipolytic activity in a liquid surfactant preparation that additionally contains a phosphonate, or so as to remove lipase-sensitive soils on fabrics or hard surfaces or for disinfection in a washing liquor that additionally contains a phosphonate.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

It was surprisingly found that a liquid surfactant preparation that comprises the combination of such a lipase with a phosphonate possesses advantageous cleaning powers on lipase-sensitive soils. Advantageously, such a surfactant preparation shows an improved cleaning power on at least one, preferably on a plurality of lipase-sensitive soils, especially on fabrics and/or hard surfaces. In a preferred development, a surfactant preparation according to the invention is moreover advantageously storage stable. Further preferred embodiments of inventive surfactant preparations show an advantageous cleaning power in regard to at least one lipase-sensitive soil at temperatures between 10° C. and 80° C., preferably also at low temperatures, for example between 10° C. and 50° C., between 10° C. and 40° C. or between 20° C. and 40° C. In regard to the prior art that was mentioned in the introduction, the present invention therefore concerns a particularly advantageous choice of a lipase for a phosphonate-containing liquid surfactant preparation.

In the context of the invention, “cleaning power” is understood to mean the brightening power on one or more soils, especially soils on the washing or soils on dishes, which are sensitive towards degradation by the lipase. Exemplary soils are carbon black/mineral oil, carbon black/olive oil, pigment/oil or sebum/carbon black, each for example on cotton fabrics, in particular of the type as listed below. In the context of the invention, both the surfactant preparation that contains the lipase or the washing or cleaning liquor formed by this surfactant preparation, as well as the lipase itself, each possesses a cleaning power. Accordingly, the cleaning power of the lipase contributes to the cleaning power of the surfactant preparation or to the washing or cleaning liquor formed by the surfactant preparation. The cleaning power is preferably determined as presented below.

“Washing or cleaning liquor” is understood to mean that solution comprising the surfactant preparation which acts on textiles or fabrics (washing liquor) or on hard surfaces (cleaning liquor), and thereby comes into contact with the soils that are present on the textiles and/or fabrics or hard surfaces. The washing or cleaning liquor usually comes into being when the washing or cleaning process begins and the surfactant preparation, in particular the washing or cleaning agent, is diluted with water, for example in a washing machine, automatic dishwasher or in another suitable container.

A lipase comprised in an inventive surfactant preparation possesses a lipolytic activity, i.e. it is capable of hydrolysing (lipolysing) lipids such as glycerides or cholesterol esters. Furthermore, the lipase comprised in an inventive surfactant preparation exists naturally in a microorganism of the type Rhizopus oryzae or Mucor javanicus. In this context, “exists naturally” means that the lipase is an individual enzyme of the microorganism. Consequently, the lipase in the microorganism can be expressed from a nucleic acid sequence that is part of the chromosomal DNA of the microorganism in its wild type form. It or the nucleic acid sequence that codes for it consequently exists in the wild type form of the microorganism and/or can be isolated from the wild type form of the microorganism. In contrast to this, if a lipase that was not naturally present in the microorganism or the nucleic acid sequence that codes for it were specifically introduced into the microorganism with the help of genetic engineering processes, then the microorganism would be enriched with the lipase or nucleic acid sequence that codes for it. However, a lipase that exists naturally in a microorganism of the type Rhizopus oryzae or Mucor javanicus, can certainly have been recombinantly produced from another organism.

The fungus Rhizopus oryzae belongs to the class of the zygomycetes (subclass Incertae sedis), herein to the order Mucorales and again herein to the family Mucoracae and to the genus Rhizopus. The fungus Mucor javanicus likewise belongs to the class of the zygomycetes (subclass Incertae sedis), herein to the order Mucorales and again herein to the family Mucoracae, herein then to the genus Mucor. The names Rhizopus oryzae and Mucor javanicus are the biological species within the respective genus.

Phosphonates are salts and organic compounds, especially esters, of phosphonic acid. The salts exist as primary (MH₂PO₃ or HP(O)(OH)(OM′)) and secondary (M′₂HPO₃ or HP(O)(OM′)₂) phosphonates, wherein M′ stands for a monovalent metal. These inorganic phosphonates are also called primary or secondary phosphites. Inorganic phosphonates result for example by reacting phosphonic acid HP(O)(OH)₂, in particular the stable tautomeric form of the phosphorous acid with one (primary) or two (secondary) equivalents of base, for example alkali metal hydroxide.

In the context of the present invention, organic P-substituted phosphonates that possess a phosphorus-carbon bond are preferred (organophosphorus compounds). Their general formula is R1P(O)(OR2)₂, with R1 and/or R2=alkyl, aryl or H, wherein the alkyl or aryl groups are further substituted or can carry additional chemical groups. Organic P-substituted phosphonates are formed for example by the Michaelis-Arbusov Reaction. Many of these phosphonates are soluble in water. Some industrially important phosphonates also carry amino group(s). Some of these amino phosphonates are structurally similar to complexants such as EDTA, NTA or DTPA and have a similar function.

In the context of the present invention, particularly preferred phosphonates are 1-hydroxyethane-1,1-diphosphonic acid (HEDP), aminotrimethylene phosphonic acid (ATMP), nitrilotrimethylene phosphonic acid (NTMP), diethylenetriaminepentamethylene phosphonic acid (DTPMP, DETPMP or DTPNT), ethylenediaminetetramethylene phosphonic acid (EDTMP) as well as 2-phosphonobutane-1,2,4-tricarboxylic acid (PBS-AM, also known as 3-carboxy-3-phosphonoadipic acid), which are mainly added in the form of their ammonium or alkali metal salts. Furthermore, combinations of the phosphonates can be added.

The sodium salt of diethylenetriaminepentamethylene phosphonic acid (DTPMP) is particularly preferred, in particular for inventive surfactant preparations that are washing agents, and/or 1-hydroxyethane-1,1-diphosphonic acid (HEDP) is particularly preferred, in particular for inventive surfactant preparations that are washing agents or dishwasher detergents, in particular automatic dishwasher detergents. These types of phosphonates are available for example under the trade names Dequest® 2066 and Dequest® 2010 (each from Thermphos Company).

In another embodiment of the invention, the surfactant preparation is characterized in that the lipase possesses an amino acid sequence that is at least 80% identical to the amino acid sequence listed in SEQ ID NO. 1. The amino acid sequence matches the amino acid sequence listed in the SEQ ID NO. 1, increasingly preferably to at least 81%, 82%, 83%, 84%, 85%, 86%, 87%, 88%, 89%, 90%, 91%, 92%, 93%, 94%, 95%, 96%, 97%, 98%, 99% and quite particularly preferably to 100%. SEQ ID NO. 1 is the sequence of a mature lipase from Rhizopus oryzae.

Inventively quite particularly preferred lipases are the lipase enzymes that are available from Amano Pharmaceuticals under the trade names Lipase M-AP10®, Lipase LE® and Lipase F® (also Lipase JV®). The Lipase F® for example exists naturally in Rhizopus oryzae. The Lipase M-AP100 for example exists naturally in Mucor javanicus.

It was inventively shown that by adding a lipase of this type to a liquid surfactant preparation that comprises a phosphonate, especially one as described above, a particularly advantageous lipolytic activity is provided in this preparation. Moreover, these types of surfactant preparations are sufficiently storage stable, in particular in regard to their retained lipolytic activity after storage, in particular after a storage time of 1 to 5 weeks, 1 to 4 weeks, 1.5 to 3 weeks and particularly preferably after 2 weeks.

Particularly preferred combinations of lipase and phosphonate in surfactant preparations according to the invention are:

Lipase that possesses an amino acid sequence that is at least 80% identical to and increasingly preferably to at least 81%, 82%, 83%, 84%, 85%, 86%, 87%, 88%, 89%, 90%, 91%, 92%, 93%, 94%, 95%, 96%, 97%, 98%, 99% and quite particularly preferably 100% identical to the amino acid sequence listed in SEQ ID NO. 1, in combination with 1-hydroxyethane-1,1-diphosphonic acid (HEDP);

Lipase that possesses an amino acid sequence that is at least 80% identical to and increasingly preferably to at least 81%, 82%, 83%, 84%, 85%, 86%, 87%, 88%, 89%, 90%, 91%, 92%, 93%, 94%, 95%, 96%, 97%, 98%, 99% and quite particularly preferably 100% identical to the amino acid sequence listed in SEQ ID NO. 1, in combination with aminotrimethylene phosphonic acid (ATMP);

Lipase that possesses an amino acid sequence that is at least 80% identical to and increasingly preferably to at least 81%, 82%, 83%, 84%, 85%, 86%, 87%, 88%, 89%, 90%, 91%, 92%, 93%, 94%, 95%, 96%, 97%, 98%, 99% and quite particularly preferably 100% identical to the amino acid sequence listed in SEQ ID NO. 1, in combination with nitrilotrimethylene phosphonic acid (NTMP);

Lipase that possesses an amino acid sequence that is at least 80% identical to and increasingly preferably to at least 81%, 82%, 83%, 84%, 85%, 86%, 87%, 88%, 89%, 90%, 91%, 92%, 93%, 94%, 95%, 96%, 97%, 98%, 99% and quite particularly preferably 100% identical to the amino acid sequence listed in SEQ ID NO. 1, in combination with diethylenetriaminepentamethylene phosphonic acid (DTPMP);

Lipase that possesses an amino acid sequence that is at least 80% identical to and increasingly preferably to at least 81%, 82%, 83%, 84%, 85%, 86%, 87%, 88%, 89%, 90%, 91%, 92%, 93%, 94%, 95%, 96%, 97%, 98%, 99% and quite particularly preferably 100% identical to the amino acid sequence listed in SEQ ID NO. 1, in combination with ethylenediaminetetramethylene phosphonic acid (EDTMP);

Lipase that possesses an amino acid sequence that is at least 80% identical to and increasingly preferably to at least 81%, 82%, 83%, 84%, 85%, 86%, 87%, 88%, 89%, 90%, 91%, 92%, 93%, 94%, 95%, 96%, 97%, 98%, 99% and quite particularly preferably 100% identical to the amino acid sequence listed in SEQ ID NO. 1, in combination with 2-phosphonobutane-1,2,4-tricarboxylic acid (PBS-AM);

Lipase M-AP108 in combination with 1-hydroxyethane-1,1-diphosphonic acid (HEDP) or aminotrimethylene phosphonic acid (ATMP) or nitrilotrimethylene phosphonic acid (NTMP) or diethylenetriaminepentamethylene phosphonic acid (DTPMP) or ethylenediaminetetramethylene phosphonic acid (EDTMP) or 2-phosphonobutane-1,2,4-tricarboxylic acid (PBS-AM);

Lipase LE® in combination with 1-hydroxyethane-1,1-diphosphonic acid (HEDP) or aminotrimethylene phosphonic acid (ATMP) or nitrilotrimethylene phosphonic acid (NTMP) or diethylenetriaminepentamethylene phosphonic acid (DTPMP) or ethylenediaminetetramethylene phosphonic acid (EDTMP) or 2-phosphonobutane-1,2,4-tricarboxylic acid (PBS-AM);

Lipase F® in combination with 1-hydroxyethane-1,1-diphosphonic acid (HEDP) or aminotrimethylene phosphonic acid (ATMP) or nitrilotrimethylene phosphonic acid (NTMP) or diethylenetriaminepentamethylene phosphonic acid (DTPMP) or ethylenediaminetetramethylene phosphonic acid (EDTMP) or 2-phosphonobutane-1,2,4-tricarboxylic acid (PBS-AM);

The identity of nucleic acid or amino acid sequences is determined by a sequence comparison. This comparison is made by aligning similar sequences in the nucleotide sequences or amino acid sequences with one another. This sequence comparison is preferably carried out based on the BLAST algorithm that is established in the prior art and usually used (see for example Altschul, S. F., Gish, W., Miller, W., Myers, E. W. & Lipman, D J. (1990) “Basic local alignment search tool.” J. Mol. Biol. 215:403-410, and Altschul, Stephan F., Thomas L. Madden, Alejandro A. Schaffer, Jinghui Zhang, Hheng Zhang, Webb Miller, and David J. Lipman (1997): “Gapped BLAST and PSI-BLAST: a new generation of protein database search programs”; Nucleic Acids Res., 25, S.3389-3402) and does so principally by aligning similar sequences of nucleotides or amino acids in the nucleotide sequences or amino acid sequences with one another. A tabular assignment of the positions is called the alignment. Another algorithm that is available from the prior art is the FASTA algorithm. Sequence alignments, particularly multiple sequence alignments, are usually created with computer programs. The Clustal series are frequently used (see for example Chema et al. (2003): Multiple sequence alignment with the Clustal series of programs, Nucleic Acid Research 31, 3497-3500), T-Coffee (see for example Notredame et al. (2000): T-Coffee: A novel method for multiple sequence alignments. J. Mol. Biol. 302, 205-217) or programs that are based on these programs or algorithms. Clustal are frequently used for example (see for example Chema et al. (2003): Multiple sequence alignment with the Clustal series of programs, Nucleic Acid Research 31, 3497-3500), T-Coffee (see for example Notredame et al. (2000): T-Coffee: A novel method for multiple sequence alignments. J. Mol. Biol. 302, 205-217) as well as BLAST or FASTA for data bank searches, or programs that are based on these programs or algorithms. In the context of the present invention, sequence comparisons and alignments are preferably created with the computer program Vector NTI® Suite 10.3 (Invitrogen Corporation, 1600 Faraday Avenue, Carlsbad, Calif., USA) with the defined default parameters.

A comparison of this type allows a statement to be made of the similarity of the compared sequences to one another. It is usually expressed in percent identity, i.e. in the fraction of the identical nucleotides or amino acid groups to the same or in an alignment to one another in corresponding positions. The wider term “homology” for amino acid sequences takes into consideration conserved amino acid exchanges, thus amino acids with similar chemical activity, as within the protein they exercise mostly similar chemical activities. Consequently, the similarity of the compared sequences can also be listed as percent homology or percent similarity. Identity and/or homology data can be gathered for complete polypeptides or genes or only for individual areas. Homologous or identical areas of various nucleic acid or amino acid sequences are therefore defined by matches in the sequences. Such areas often possess identical functions. They can be small and include only a few nucleotides or amino acids. It is frequently the case that such small areas execute essential functions for the total activity of the protein. Consequently, it can be worthwhile to obtain sequence matches only for individual, optionally small areas. However, when not otherwise stated, identity or homology data in the present application refer to the total length of the relevant listed nucleic acid or amino acid sequence.

In another embodiment of the invention, a surfactant preparation according to the invention is further characterized in that its cleaning power corresponds to at least that of a surfactant preparation that contains a lipase that possesses an amino acid sequence according to SEQ ID NO. 1, wherein the cleaning power is determined in a washing system that comprises a washing agent dosed between 2.0 and 9.0 gram per liter washing liquor as well as the lipase, wherein the lipases to be compared are employed in equal activities and the cleaning power is determined for one or more of the soils carbon black/mineral oil on cotton, carbon black/olive oil on cotton, pigment/oil on cotton or sebum/carbon black on cotton, in particular for one or more of the soils
carbon black/mineral oil on cotton: product no. C-01 obtained from CFT (Center For Testmaterials) B.V. Vlaardingen, Netherlands
carbon black/olive oil on cotton: product no. C-02 obtained from CFT (Center For Testmaterials) B.V. Vlaardingen, Netherlands
pigment/oil on cotton: product no. C-09 obtained from CFT (Center For Testmaterials) B.V. Vlaardingen, Netherlands
sebum/carbon black on cotton: product no. C-S-32 obtained from CFT (Center For Testmaterials) B.V. Vlaardingen, Netherlands,
   by measuring the degree of whiteness of the washed fabrics, wherein the washing process lasts for at least 30 minutes, optionally 60 minutes, at a temperature of 40° C. and the water hardness of the water is between 15.5 and 16.5 (German hardness).

The washing agent for the wash system is a liquid washing agent, formulated as follows (all figures in weight percent): 0.3-0.5% xanthan, 0.2-0.4% defoamer, 6-7% glycerin, 0.3-0.5% ethanol, 4-7% FAEOS (fatty alcohol ether sulfate), 24-28% non-ionic surfactants, 1% boric acid, 1-2% sodium citrate (dihydrate), 2-4% soda, 14-16% cocoanut fatty acids, 0.5% HEDP, 1-hydroxyethane-(1,1-diphosphonic acid)), 0-0.4% PVP (polyvinyl pyrrolidone) 0-0.5% optical brightener, 0-0.001% % colorant, remainder demineralized water. The lipase in this regard is incorporated in a concentration of 0.0001-0.06 wt %, preferably 0.001 to 0.006 wt %, in the washing agent, based on the active protein. The liquid washing agent is preferably dosed between 2.0 and 9.0, preferably between 2.5 and 8.0, between 3.0 and 7.0 and particularly preferably 3.5 grams per liter of wash liquor. The washing is preferably carried out in a pH range between pH 8 and pH 10.5, preferably between pH 8 and pH 9. The lipase activity in the washing liquor is not equal to zero at the beginning of the wash.

The whiteness degree, i.e. the brightening of the soils as a measure of the cleaning power, is preferably determined with optical measurement methods, preferably photometrically. A suitable apparatus for this is the Minolta CM508d spectrometer, for example. The apparatuses used for the measurement are normally calibrated with a white standard, preferably with a white standard that was delivered with the apparatus.

The equal activity addition of the relevant lipase ensures that even for a possible divergence of the ratios of active substance to total protein (the value of the specific activity) each of the enzymatic properties, thus for example the washing power on certain soils, are compared. It is generally true that a low specific activity can be compensated by adding a larger amount of protein.

The lipase activity is determined according to the typical technical procedure, that is preferably as described in Bruno Stellmach, “Bestimmungsmethoden Enzyme far Pharmazie, Lebensmittelchemie, Technik, Biochemie, Biologie, Medizin” (Steinkopff Verlag Darmstadt, 1988, p. 172ff). Here, lipase containing samples are added to an olive oil emulsion in emulsifier-containing water and incubated at 30° C. and pH 9.0. This liberates fatty acids. These are continually titrated with an auto-titrator for 20 minutes with 0.01 N sodium hydroxide, such that the pH remains constant (“pH-stat-titration”). The lipase activity is determined by the sodium hydroxide consumption with reference to a reference lipase sample.

Numerous lipases are formed as so called pre-proteins, i.e. formed together with a pro-peptide and/or a signal peptide. Pro-peptides and signal peptides often have N-terminal sequences. Signal peptides and/or pro-peptides are split off in the course of the folding and/or secretion process of the protein, such that after the cleavage of the pro-peptide and/or signal peptide the then mature lipase exercises its catalytic activity without the originally present N-terminal amino acids. For technical applications in general and especially in the context of the invention, the mature lipases, i.e. the processed enzymes after their production, are preferred over the pre-proteins. Furthermore, the lipases can be modified from the cells producing them after the production of the polypeptide chain, for example by the attachment of sugar molecules, by formylations, aminations, etc. Such modifications are post-translational modifications and can, although do not have to, exert an influence on the function of the lipase.

Furthermore, the lipase comprised in a surfactant preparation according to the invention can be adsorbed on carriers and/or be embedded in a matrix in order to protect them against premature inactivation. In the washing or cleaning liquor, i.e. under conditions of use, the lipase is then released and can develop its lipolytic activity.

In a preferred embodiment of the invention, the surfactant preparation comprises the phosphonate in an amount of 0.01 to 4 wt %.

Further preferred amounts of the phosphonate comprised in the surfactant preparation are 0.01 to 3 wt %, 0.01 to 2.5 wt %, 0.02 to 2.4 wt %, 0.02 to 2 wt %, 0.03 to 1.5 wt % or 0.05 to 1 wt %.

The lipase is preferably comprised in a surfactant preparation according to the invention in an amount of 1×10⁻⁸ to 5 wt % based on active protein. The lipase is comprised with increasing preference in a surfactant preparation according to the invention in an amount of 1×10⁻⁷ to 3 wt %, 0.00001-1 wt %, 0.0002-0.8 wt %, and particularly preferably 0.0008-0.4 wt %, based on active protein. The protein concentration can be determined using known methods, for example the BCA Process (bicinchoninic acid; 2,2′-biquinolyl-4,4′-dicarboxylic acid) or the biuret process (A. G. Gornall, C. S. Bardawill and M. M. David, J. Biol. Chem., 177 (1948), pp. 751-766). The active enzyme protein content can be determined by means of active-site titration of the lipase preparation according to Rotticci et al.: An active-site titration method for lipases (Biochim. Biophys. Acta 1483(1), pages 132-140). For this, various concentrations of the enzyme in a suitable buffer system are provided with an excess of inhibitor (methyl-p-nitrophenyl-n-hexyl phosphonate) and the released quantity of p-nitrophenolate is determined spectrophotometrically at 400 nm.

In the context of the present invention, a “surfactant preparation” is understood to mean any type of composition that comprises at least one surfactant. Such a composition preferably comprises a surfactant as described further below.

All liquid or free-flowing dosage forms can be used as the liquid surfactant preparation. In the context of the present application, “free-flowing” is understood to mean preparations that are pourable and have viscosities up to several 10 000 mPas. The viscosity can be measured using standard methods (for example using a Brookfield-Viscosimeter LVT-II at 20 rpm and 20° C., spindle 3) and is preferably in the range of 5 to 10 000 mPas. Preferred surfactant preparations have viscosities from 10 to 8000 mPas, particularly preferably between 120 and 3000 mPas. In the context of the present invention, a liquid surfactant preparation can therefore also be in gel form or in paste form, it can be a homogenous solution or suspension, it can be sprayable for example or be packaged in other usual dosage forms.

A liquid surfactant preparation according to the invention can be used as such or after dilution with water, especially for cleaning fabrics and/or hard surfaces. Such a dilution can be produced easily, in that a measured amount of the surfactant preparation is diluted in an additional amount of water in defined weight ratios of surfactant preparation: water, and optionally with shaking, in order to ensure a uniform distribution of the surfactant preparation in the water. Possible weight or volume ratios for the dilutions are from 1:0 surfactant preparation: water to 1:10000 or 1:20000 surfactant preparation: water, preferably from 1:10 to 1:2000 surfactant preparation: water.

In the context of the present invention, a surfactant preparation can therefore also be the washing or cleaning liquor itself.

In a preferred embodiment, the surfactant preparation is a washing agent, cleaning agent or disinfectant. Washing agents include all conceivable types of washing agents, especially washing agents for fabrics, carpets or natural fibers. They can be provided for manual and/or automatic use. The washing agents further include washing auxiliaries that in the course of a manual or automatic fabric wash are metered into the actual washing agent in order to achieve another effect. The cleaning agents include all agents, likewise in any cited dosage forms, for cleaning and/or disinfecting hard surfaces, manual and automatic dishwasher detergents, carpet cleaners, scouring agents, glass cleaners, WC-fragrant rinses, etc. Finally, fabric pre- and after-conditioners are on the one hand those materials that are brought into contact with the washing prior to the actual wash, for example in order to partially dissolve intractable soils, and on the other hand those materials that in a step that follows on from the actual fabric wash, to confer additional desirable properties to the washing, such as a pleasant touch, absence of creasing or a low residual static charge. The last mentioned agents include inter alia the fabric softeners. Disinfectants are for example hand disinfectants, surface disinfectants and instrument disinfectants which can also be in any cited dosage form. A disinfectant preferably reduces germs by a factor of at least 10⁴, i.e. not more than a single survivor from an original 10 000 germs capable of reproduction (colony forming units—cfu), wherein viruses in this regard are not classified as germs as they do not possess cytoplasma and do not have their own metabolism. Preferred disinfectants reduce germs by a factor of at least 10⁵.

Anionic, non-ionic, zwitterionic and/or amphoteric surfactants can be added as the surfactant(s). Mixtures of anionic and non-ionic surfactants are preferred from the industrial application viewpoint. The total surfactant content of the liquid surfactant preparation is preferably below 60 wt % and particularly preferably below 45 wt %, based on the total liquid surfactant preparation.

Suitable non-ionic surfactants include alkoxylated fatty alcohols, alkoxylated fatty acid alkyl esters, fatty acid amides, alkoxylated fatty acid amides, polyhydroxyfatty acid amides, alkylphenol polyglycol ethers, amine oxides, alkyl polyglucosides and mixtures thereof.

Preferred non-ionic surfactants are alkoxylated, advantageously ethoxylated, particularly primary alcohols preferably containing 8 to 18 carbon atoms and, on average, 1 to 12 moles of ethylene oxide (EO) per mole of alcohol, in which the alcohol group may be linear or, preferably, methyl-branched in the 2-position or may contain e.g. linear and methyl-branched groups in the form of the mixtures typically present in Oxo alcohol residues. In particular, however, alcohol ethoxylates with linear alcohol groups of natural origin with 12 to 18 carbon atoms, for example from coco-, palm-, tallow- or oleyl alcohol, and an average of 2 to 8 EO per mole alcohol are preferred. Exemplary preferred ethoxylated alcohols include C₁₂₋₁₄ alcohols with 3 EO, 4 EO or 7 EO, C₉₋₁₁ alcohol with 7 EO, C₁₃₋₁₅ alcohols with 3 EO, 5 EO, 7 EO or 8 EO, C₁₂₋₁₈ alcohols with 3 EO, 5 EO or 7 EO and mixtures thereof, such as mixtures of C₁₂₋₁₄ alcohol with 3 EO and C₁₂₋₁₈ alcohol with 7 EO. The cited degrees of ethoxylation constitute statistically average values that can be a whole or a fractional number for a specific product. Preferred alcohol ethoxylates have a narrowed homolog distribution (narrow range ethoxylates, NRE). In addition to these non-ionic surfactants, fatty alcohols with more than 12 EO can also be used. Examples of these are tallow fatty alcohol with 14 EO, 25 EO, 30 EO or 40 EO. Also, non-ionic surfactants that comprise the EO and PO groups together in the molecule are employable according to the invention. Further suitable is also a mixture of a (highly) branched ethoxylated fatty alcohol and a linear ethoxylated fatty alcohol, such as for example a mixture of a C₁₆₋₁₈ fatty alcohol with 7 EO and 2-propylheptanol with 7 EO. The surfactant preparation particularly preferably comprises a C₁₂₋₁₈ fatty alcohol with 7 EO or a C₁₃₋₁₅ Oxo alcohol with 7 EO as the non-ionic surfactant.

The content of non-ionic surfactants is preferably 3 to 40 wt %, advantageously 5 to 30 wt % and particularly 7 to 20 wt %, in each case based on the total surfactant preparation.

The surfactant preparation can also comprise anionic surfactants in addition to the non-ionic surfactants. Sulfonates, sulfates, soaps, alkyl phosphates, anionic silico-surfactants and mixtures thereof are preferably employed as the anionic surfactant.

Suitable surfactants of the sulfonate type are, advantageously C₉₋₁₃ alkylbenzene sulfonates, olefin sulfonates, i.e. mixtures of alkene and hydroxyalkane sulfonates and disulfonates, as are obtained, for example, from C₁₂₋₁₈ monoolefins having a terminal or internal double bond, by sulfonation with gaseous sulfur trioxide and subsequent alkaline or acidic hydrolysis of the sulfonation products. C₁₂₋₁₈ Alkane sulfonates and the esters of α-sulfofatty acids (ester sulfonates), e.g. the α-sulfonated methyl esters of hydrogenated coco, palm nut or tallow fatty acids are likewise suitable.

Preferred alk(en)yl sulfates are the alkali metal and especially the sodium salts of the sulfuric acid half-esters derived from the C₁₂-C₁₈ fatty alcohols, for example from coconut butter alcohol, tallow alcohol, lauryl, myristyl, cetyl or stearyl alcohol or from C₁₀-C₂₀ Oxo alcohols and those half esters of secondary alcohols of these chain lengths. The C₁₂-C₁₆ alkyl sulfates and C₁₂-C₁₅ alkyl sulfates as well as C₁₄-C₁₅ alkyl sulfates are preferred on the grounds of washing performance. 2,3-Alkyl sulfates are also suitable anionic surfactants.

Sulfuric acid mono-esters derived from straight-chain or branched C₇₋₂₁ alcohols ethoxylated with 1 to 6 moles ethylene oxide are also suitable, for example 2-methyl-branched C₉₋₁₁ alcohols with an average of 3.5 mole ethylene oxide (EO) or C₁₂₋₁₈ fatty alcohols with 1 to 4 EO.

Soaps are also preferred anionic surfactants. Saturated and unsaturated fatty acid soaps are suitable, such as the salts of lauric acid, myristic acid, palmitic acid, stearic acid, (hydrogenated) erucic acid and behenic acid, and especially soap mixtures derived from natural fatty acids such as coconut oil fatty acid, palm kernel oil fatty acid, olive oil fatty acid or tallow fatty acid.

The anionic surfactants, including the soaps, can be present in the form of their sodium, potassium or magnesium or ammonium salts. The anionic surfactants are preferably present in the form of their sodium salts. Further preferred counter ions for the anionic surfactants are also the protonated forms of choline, triethylamine or methylethylamine.

The anionic surfactant content of a surfactant preparation can be 1 to 40 wt %, preferably 5 to 30 wt % and quite particularly preferably 10 to 25 wt %, each based on the total surfactant preparation.

In another embodiment of the invention, the surfactant preparation additionally includes a component that is selected from

i. an anionic and/or polyanionic substance, and/or
ii. a cationic and/or polycationic substance, and/or
iii. a substance that possesses hydroxyl and/or polyhydroxyl group(s).

It was observed that the addition of such substances further improves the cleaning power of surfactant preparations, especially liquid washing or cleaning agents that comprise a lipase, in particular one such as described above, in particular at a temperature between 10° C. and 80° C. and preferably at comparatively low temperatures, in particular between 10° C. and 50° C., between 10° C. and 40° C., between 10° C. and 30° C. and/or between 20° C. and 40° C.

The substances listed under i. above concern anionic or polyanionic substances, i.e. these substances carry at least one and preferably a plurality of negative charges. They preferably concern a polymer containing at least one negatively charged monomer, preferably a plurality of negatively charged monomers. Accordingly, this inventively preferred polymer is a negatively charged polymer. Exemplary preferred are polymers of organic acids or their salts, especially polyacrylates and/or polysugar acids and/or polyacrylate copolymers and/or polysugar copolymers. In this regard, further preferred compounds are polyacrylic sulfonates or polycarboxylates and their salts, copolymers or salts of the copolymers.

Exemplary particularly preferably added substances are Acusol 587D (polyacrylic sulfonate; Rohm & Haas/Dow Chemical), Acusol 445N (polycarboxylate sodium salt; Rohm & Haas/Dow Chemical), Acusol 590 (polyacrylate copolymer; Rohm & Haas/Dow Chemical), Acusol 916 (polyacrylate sodium salt; Rohm & Haas/Dow Chemical), Sokalan CP42 (modified polycarboxylate sodium salt; BASF), Sokalan PA 30CL (polycarboxylate sodium salt; BASF), Dequest P 9000 (polymaleic acid; Thermphos), alginic acid, poly-2-acrylamido-2-methyl-1-propane sulfonic acid, poly-4-styrene sulfonic acid co-maleic acid sodium salt, polyacrylamide co-acrylic acid sodium salt, polymethacrylic acid sodium salt, polymethyl vinyl ether-alt-maleic acid or polyvinylsulfonic acid sodium salt.

The substances listed under ii. concern cationic or polycationic substances, i.e. these substances carry at least one and preferably a plurality of positive charges. They preferably concern a polymer containing at least one positively charged monomer, preferably a plurality of positively charged monomers. Accordingly, this inventively preferred polymer is a positively charged polymer. Exemplary preferred compounds in this regard are salts of the polyamines, polyethylene imines or their copolymers, salts of the polyallylamines, salts of the polydiallyldimethylammonium compounds or poly(acrylamide-co-diallyldimethylammonium compounds.

The substances listed under iii. concern substances that carry at least one hydroxyl and/or polyhydroxyl group and preferably possess a plurality of hydroxyl and/or polyhydroxyl groups. In this regard, polyvinyl alcohols, for example are preferred, for example those that are available under the trade name Mowiol (Kremer Pigmente GmbH & Co. KG).

At this point, it is expressly pointed out that an actual substance can belong to one or more of the previously cited groups i. to iii. For example it can concern an anionic polymer that possesses one or more hydroxyl and/or polyhydroxyl group(s). A substance of this type then belongs to the groups i. and iii. Likewise, a cationic polymer that possesses one or more hydroxyl and/or polyhydroxyl group(s) belongs to the groups ii. and iii.

In the context of the present invention, derivatives of the abovementioned substances belonging to i., ii. or iii. can likewise be added. In the context of the present application, a derivative is understood to mean a substance that, starting from one of the previously cited substances, is chemically modified, for example by the conversion of a side chain or by covalently bonding another compound onto the substance. Such a compound can concern for example low molecular weight compounds such as lipids or mono-, oligo- or polysaccharides or amines or amine compounds. Moreover, the substance can be glycolyzed, hydrolyzed, oxidized, N-methylated, N-formylated, N-acetylated or comprise methyl, formyl, ethyl, acetyl, t-butyl, anisyl, benzyl, trifluoroacetyl, N-hydroxysuccinimide, t-butyloxycarbonyl, benzoyl, 4-methylbenzyl, thioanicyl, thiocresyl, benzyloxymethyl, 4-nitrophenyl, benzyloxycarbonyl, 2-nitrobenzoyl, 2-nitrophenylsulfenyl, 4-toluenesulfonyl, pentafluorophenyl, diphenylmethyl, 2-chlorobenzyloxycarbonyl, 2,4,5-trichlorophenyl, 2-bromobenzyloxycarbonyl, 9-fluorenylmethyloxycarbonyl, triphenylmethyl, 2,2,5,7,8-pentamethyl-chroman-6-sulfonyl. Likewise, a derivative is understood to mean the covalent or non-covalent bonding of the substance onto a macromolecular carrier, just as also a non-covalent inclusion in suitable macromolecular cage structures. Coupling with other macromolecular compounds, such as for example polyethylene glycol, can also be carried out. Further preferred chemical modifications are the modification of one or more of the chemical groups —COOH, —OH, —NH, —NH₂—SH to —COOR, —OR, —NHR, —NR2, —NHR, —NR, —SR; wherein:

R is —CH═CH—R2, —C(R2)=CH₂, —C(R2)=C(R3), —CH═NR2, —C(R2)=N—R3, a 4-7 carbon ring system with or without substitution, a 4-7 nitrogen heterocycle with or without substitution, or a C₂ to C₈ carbon chain with 1 to 5 double or triple bonds with substitutions selected from R1, R2, or R3, wherein

R1 is H, —R, —NO₂, —CN, halide substituent, —N₃, —C₁₋₈ alkyl, —(CH₂)ₙCO₂R2, —C₂₋₈ alkenyl-CO₂R2, —O(CH₂)ₙCO₂R2, —C(O)NR2R3, —P(O)(OR2)₂, alkyl substituted tetrazol-5-yl, —(CH₂)ₙO(CH₂)ₙ aryl, —NR2R3, —(CH₂)ₙOR2, —(CH₂)ₙSR2, —N(R2)C(O)R3, —S(O₂)NR2R3, —N(R2)S(O₂)R3, —(CHR2)ₙNR2R3, —C(O)R3, (CH₂)ₙN(R3)C(O)R3, —N(R2)CR2R3, substituted or unsubstituted (CH₂)ₙ-cycloalkyl, substituted or unsubstituted (CH₂)ₙ-phenyl, or -ring; wherein n is a number greater than 1;

R2 is H, halide substituent, -alkyl, -haloalkyl, —(CH₂)ₙ-phenyl, —(CH₂)1-3-biphenyl, —(CH₂) 1-4-Ph-N(SO₂—C₁₋₂-alkyl)₂, —CO(CHR1)ₙ—OR1, —(CHR1)ₙ-heterocycle, —(CHR1)ₙ—NH—C—R1, —(CHR1)ₙ—NH—SO₂R1, —(CHR1)ₙ-Ph-N(SO₂—C1-2-alkyl)₂, —(CHR1)ₙ—C(O)(CHR1)-NHR1, —(CHR1)ₙ—C(S)(CHR1)-NHR1, —(CH₂)ₙO(CH₂)ₙCH₃, —CF₃, —C₂-C₅acyl, —(CHR1)ₙOH, —(CHR1)ₙCO₂R1, —(CHR1)ₙ—O-alkyl, —(CHR1)ₙ—O —(CH₂)ₙ—O-alkyl, —(CHR1)ₙ—S-alkyl, —(CHR1)ₙ—S(O)-alkyl, —(CHR1)ₙ—S(O₂)-alkyl, —(CHR1)ₙ—S(O₂)—NHR3, —(CHR3)ₙ—N₃, —(CHR3)ₙNHR4, a C₂ to C₈ chain alkene chain with 1 to 5 double bonds, a C₂ to C₈ chain alkyne chain with 1 to 5 triple bonds, substituted or unsubstituted —(CHR3)ₙ heterocycle, substituted or unsubstituted saturated or unsaturated —(CHR3)ₙ cycloalkyl; wherein n is a number greater than 1 and R1 and R3 can be the same or different;

R3 is H, —OH, —CN, substituted alkyl, —C₂ to C₈ alkenyl, substituted or unsubstituted cycloalkyl, —N(R1)R2, saturated or unsaturated C₅ to C₇ heterocycle or heterobicycle of 4 to 7 carbon atoms, —NR1, —NR2, —NR1R2 consisting of a saturated or unsaturated heterocycle or a heterobicycle of 4 to 7 carbon atoms;

R4 is H, —(CH₂)ₙOH, —C(O)OR5, —C(O)SR5, —(CH₂)ₙC(O)NR6R7, —O—C(O)—O—R6, an amino acid or a peptide; wherein n is a number between 0 and 4;

R5 is H,

R6 is —C(R7)-(CH₂)ₙ—O—C(O)—R8, —(CH₂)ₙ—C(R7)-O—C(O)R8, —(CH₂)ₙ—C(R7)-O—C(O)—O —R8, or —C(R7)-(CH₂)ₙ—O—C(O)—O—R8; wherein n is a number between 0 and 4; and

R7 and R8 are each H, alkyl, substituted alkyl, aryl, substituted aryl, alkenyl, substituted alkenyl, alkynyl, substituted alkynyl, heterocyclic, substituted heterocyclic, alkylaryl, substituted alkylaryl, cycloalkyl, substituted cycloalkyl, or CH₂CO₂alkyl, wherein R7 and R8 can be the same or different.

It is also inventively possible to employ all possible combinations of the previously cited substances that belong to i., ii. or iii. and/or their derivatives.

In another embodiment of the invention, the surfactant preparation additionally contains at least one additional ingredient that is selected from the group consisting of builder, peroxygen compound, bleach activator, non-aqueous solvent, acid, water-soluble salt, thickener, disinfecting ingredient as well as combinations thereof.

The incorporation of one or more of the additional ingredients proves to be advantageous as in this way a further improved cleaning power and/or disinfection is achieved. The improved cleaning power and/or disinfection is preferably based on a synergistic interaction of at least two ingredients. Such a synergy can be achieved particularly by the combination of the comprised lipase and/or the comprised phosphonate with one of the following described builders and/or with one of the following described peroxygen compounds and/or with one of the following described bleach activators and/or with one of the following described non-aqueous solvents and/or with one of the following described acids and/or with one of the following described water-soluble salts and/or with one of the following described thickeners and/or with one of the following described disinfecting ingredients.

Silicates, aluminum silicates (particularly zeolites), carbonates, salts of organic di- and polycarboxylic acids as well as mixtures of these materials can be particularly cited as builders that can be comprised in the surfactant preparation.

Organic builders that can be present in the surfactant preparation are, for example, the polycarboxylic acids usable in the form of their sodium salts, polycarboxylic acids in this context being understood to be carboxylic acids that carry more than one acid function.

These include, for example, citric acid, adipic acid, succinic acid, glutaric acid, malic acid, tartaric acid, maleic acid, fumaric acid, sugar acids, amino carboxylic acids, nitrilotriacetic acid (NTA), methylglycine diacetic acid (MGDA) and their derivatives and mixtures thereof. Preferred salts are the salts of polycarboxylic acids such as citric acid, adipic acid, succinic acid, glutaric acid, tartaric acid, sugar acids and mixtures thereof.

Polymeric polycarboxylates are also suitable as builders. These are for example the alkali metal salts of polyacrylic acid or polymethacrylic acid, for example those with a relative molecular mass of 600 to 750 000 g/mol.

Particularly suitable polymers are polyacrylates, which preferably have a molecular mass of 1000 to 15 000 g/mol. By virtue of their superior solubility, preferred representatives of this group can again be the short-chain polyacrylates, which have molecular weights of 1000 to 10 000 g/mol and particularly preferably 1000 to 5000 g/mol.

Further suitable copolymeric polycarboxylates are particularly those of acrylic acid with methacrylic acid and of acrylic acid or methacrylic acid with maleic acid. In order to improve the water solubility, the polymers can also comprise allyl sulfonic acids as the monomer, such as allyloxybenzene sulfonic acid and methallyl sulfonic acid.

Preferably however, soluble builders, such as for example citric acid, or acrylic polymers with a molecular mass of 1000 to 5000 g/mol, are preferably incorporated in the liquid surfactant preparation.

The molecular masses mentioned for polymeric polycarboxylates in the context of this specification are weight-average molecular weights M_{w} of the particular acid form which were fundamentally determined by means of gel permeation chromatography (GPC) using a UV detector. The measurement was carried out against an external polyacrylic acid standard, which provides realistic molecular weight values by virtue of its structural similarity to the investigated polymers. These values differ significantly from the molecular weights measured against polystyrene sulfonic acids as the standard. The molecular masses measured against polystyrene sulfonic acids are generally significantly higher than the molecular masses mentioned in this specification.

These types of organic builders can be comprised as desired in amounts of up to 40 wt %, particularly up to 25 wt % and preferably from 1 wt % to 8 wt %. Amounts close to the cited upper limit are preferably incorporated in pasty or liquid, particularly aqueous, surfactant preparations.

The peroxygen compounds that are incorporated in surfactant preparations according to the invention particularly include organic peracids or peracid salts of organic acids, such as phthalimidopercaproic acid, perbenzoic acid or salts of diperoxydodecanedioic acid, hydrogen peroxide and inorganic salts that liberate hydrogen peroxide under the washing conditions, such as perborate, percarbonate, persilicate and/or persulfate like Caroat. When a preparation comprises peroxygen compounds then the latter are present in amounts of preferably up to 50 wt %, especially 5 wt % to 30 wt %. The addition of minor quantities of known bleaching agent stabilizers, such as for example phosphonates, borates or metaborates and metasilicates as well as magnesium salts such as magnesium sulfate, can be useful.

Bleach activators, which can be incorporated, are compounds which, under perhydrolysis conditions, yield aliphatic peroxycarboxylic acids having preferably 1 to 10 carbon atoms, in particular 2 to 4 carbon atoms, and/or optionally substituted perbenzoic acid. Substances, which carry O-acyl and/or N-acyl groups of said number of carbon atoms and/or optionally substituted benzoyl groups, are suitable. Preference is given to polyacylated alkylenediamines, in particular tetraacetyl ethylenediamine (TAED), acylated triazine derivatives, in particular 1,5-diacetyl-2,4-dioxohexahydro-1,3,5-triazine (DADHT), acylated glycolurils, in particular tetraacetyl glycoluril (TAGU), N-acylimides, in particular N-nonanoyl succinimide (NOSI), acylated phenol sulfonates, in particular n-nonanoyl- or isononanoyloxybenzene sulfonate (n- or iso-NOBS), carboxylic acid anhydrides, in particular phthalic anhydride, acylated polyhydric alcohols, in particular triacetin, ethylene glycol diacetate and 2,5-diacetoxy-2,5-dihydrofuran, and enol esters as well as acetylated sorbitol and mannitol or their described mixtures (SORMAN), acylated sugar derivatives, in particular pentaacetyl glucose (PAG), pentaacetyl fructose, tetraacetyl xylose and octaacetyl lactose as well as acetylated, optionally N-alkylated glucamine and gluconolactone, and/or N-acylated lactams, for example N-benzoyl caprolactam. The hydrophilically substituted acyl acetals and the acyl lactams are also preferably used. Combinations of conventional bleach activators may also be used. These types of bleach activators, in particular in the presence of the abovementioned bleaching agents that release hydrogen peroxide, can be comprised in the usual quantity range, preferably in amounts of 0.5 wt % to 10 wt %, in particular 1 wt % to 8 wt %, based on the total surfactant preparation, but are preferably totally absent when percarboxylic acid is added as the sole bleaching agent.

In addition to the conventional bleach activators or instead of them, sulfonimines and/or bleach boosting transition metal salts or transition metal complexes can be comprised as the so-called bleach catalysts.

The surfactant preparations according to the invention are liquid and preferably comprise water as the main solvent. In addition or alternatively, non-aqueous solvents can be added to the surfactant preparation. Suitable non-aqueous solvents include monohydric or polyhydric alcohols, alkanolamines or glycol ethers, in so far that they are miscible with water in the defined concentration range. The solvents are preferably selected from ethanol, n-propanol, i-propanol, butanols, glycol, propane diol, butane diol, glycerin, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol monoethyl ether, di-isopropylene glycol monomethyl ether, di-isopropylene glycol monoethyl ether, methoxytriglycol, ethoxytriglycol, butoxytriglycol, 1-butoxyethoxy-2-propanol, 3-methyl-3-methoxybutanol, propylene glycol t-butyl ether, di-n-octyl ether as well as mixtures of these solvents. However, it is preferred that the surfactant preparation comprises a polyol as the non-aqueous solvent. In particular, the polyol can include glycerin, 1,2-propane diol, 1,3-propane diol, ethylene glycol, diethylene glycol and/or dipropylene glycol. The surfactant preparation particularly preferably comprises a mixture of a polyol and a monohydric alcohol. Non-aqueous solvents can be incorporated in the surfactant preparation in amounts between 0.5 and 15 wt %, preferably, however below 12 wt

A pH resulting from mixing the usual components can be adjusted to a desired level, in that the surfactant preparations can comprise acids that are compatible with the system and the environment, particularly citric acid, acetic acid, tartaric acid, malic acid, glycolic acid, succinic acid, glutaric acid and/or adipic acid, and also mineral acids, particularly sulfuric acid or bases, particularly ammonium hydroxide or alkali metal hydroxides. These types of pH adjustors are preferably comprised in the surfactant preparations in amounts of not more than 20 wt %, in particular from 1.2 wt % to 17 wt %.

In the context of the invention, a surfactant preparation can additionally comprise one or more water-soluble salts that serve, for example, to adjust the viscosity. In this regard they can be inorganic or organic salts. Here, inorganic salts that can be incorporated are preferably selected from the group that includes colorless water-soluble halides, sulfates, sulfites, carbonates, hydrogen carbonates, nitrates, nitrites, phosphates and/or oxides of the alkali metals, of the alkaline earth metals, of aluminum and/or of transition metals; in addition, ammonium salts can be incorporated. In this regard, halides and sulfates of the alkali metals are particularly preferred; consequently the inorganic salt is preferably selected from the group that includes sodium chloride, potassium chloride, sodium sulfate, potassium sulfate as well as their mixtures. Exemplary organic salts that can be incorporated are colorless water-soluble alkali metal, alkaline earth metal, ammonium, aluminum and/or transition metal salts of carboxylic acids. The salts are preferably selected from the group that includes formate, acetate, propionate, citrate, malate, tartrate, succinate, malonate, oxalate, lactate as well as mixtures thereof.

A surfactant preparation according to the invention can comprise one or more thickeners to thicken it. The thickener is preferably selected from the group that includes xanthan, guar, carrageenan, agar agar, gellan, pectin, locust bean flour and mixtures thereof. These compounds are also effective thickeners in the presence of inorganic salts. In a particularly preferred embodiment, the surfactant preparation comprises xanthan as the thickener, as xanthan thickens effectively even in the presence of high salt concentrations and prevents a macroscopic separation of the continuous phase. In addition, the thickener stabilizes the continuous surfactant-poor phase and prevents a macroscopic phase separation.

Alternatively, (meth)acrylic acid (co)polymers can also be employed as the thickener. Exemplary suitable acrylic and methacrylic (co)polymers include the high molecular weight homopolymers of acrylic acid, crosslinked with a polyalkenyl polyether, in particular an allyl ether of saccharose, pentaerythritol or propylene (INCI name according to the “International Dictionary of Cosmetic Ingredients” of “The Cosmetic, Toiletry and Fragrance Association (CTFA)”: Carbomer), which are also called carboxyvinyl polymers. Polyacrylic acids of this type are available inter alia under the trade names Polygel® and Carbopol®. In addition, the following acrylic acid copolymers are suitable, for example: (i) copolymers of two or more monomers of the group of the acrylic acid, methacrylic acid and their simple esters, preferably formed with C₁₋₄ alkanols (INCI Acrylates Copolymer), which are available for example under the trade names Aculyn®, Acusol® or Tego® Polymer; (ii) crosslinked high molecular weight acrylic acid copolymers, to which belong for example the copolymers of C₁₀₋₃₀ alkyl acrylates with one or more monomers of the group of acrylic acid, methacrylic acid and their simple esters, preferably formed with C₁₋₄ alkanols, crosslinked with an allyl ether of saccharose or of pentaerythritol (INCI Acrylates/C₁₀₋₃₀ Alkyl Acrylate Crosspolymer) and which are available under the trade name Carbopol®. Further suitable polymers are (meth)acrylic acid (co)polymers of the Sokalan® type.

It can be preferred that the surfactant preparation according to the invention comprises a (meth)acrylic acid (co)polymer in combination with another thickener, preferably xanthan. The surfactant preparation can comprise 0.05 to 1.5 wt % and preferably 0.1 to 1 wt % thickener, each based on the total surfactant preparation. The amount of added thickener depends in this regard on the type of thickener and the desired degree of thickening.

A disinfecting ingredient is particularly understood to mean ingredients that possess an antimicrobial or antiviral activity, i.e. kill germs. In this regard, the germ-killing effect depends on the content of the disinfecting ingredient in the surfactant preparation, wherein the germ-killing activity decreases with decreasing contents of disinfecting ingredient or increasing dilution of the surfactant preparation.

A preferred disinfecting ingredient is ethanol or propanol. Due to their solvent properties and their germicidal action these monohydric alcohols are often generally employed in disinfectants and also in cleaning agents. In this regard, the term “propanol” includes both 1-propanol (n-propanol) as well as 2-propanol (“isopropanol”). Ethanol and/or propanol is comprised for example in an amount totaling 10 to 65 wt %, preferably 25 to 55 wt % in the surfactant preparation. Another preferred disinfecting ingredient is tea tree oil. Here it concerns the ethereal oil of the Australian tea tree (Melaleuca alternifolia), an evergreen shrub of the genus Melaleuca, indigenous to New South Wales and Queensland, as well other tea tree types from various genera (e.g. Baecka, Kunzea and Leptospermum) in the family of the Myrtaceae). The tea tree oil is obtained by steam distillation of the leaves and branch tips of this tree and is a mixture of ca. 100 substances; the major constituents include (+)-terpinen-4-ol, α-terpinenes, terpinols, terpineol, pinene, myrcene, phellandrene, p-cymene, limonene and 1,8-cineol. Tea tree oil is comprised for example in an amount of 0.05 to 10 wt %, preferably 0.1 to 5 wt %, in the virucidal treatment solution. Another preferred disinfecting ingredient is lactic acid. Lactic acid or 2-hydroxypropionic acid is a fermentation product that is produced from various microorganisms. It is weakly antibiotically active. Lactic acid is comprised for example in amounts of up to 10 wt %, preferably 0.2 to 5.0 wt % in the surfactant preparation.

Additional disinfecting ingredients are for example active substances from the groups of the alcohols, aldehydes, antimicrobial acids or their salts, carboxylic acid esters, acid amides, phenols, phenol derivatives, diphenyls, diphenylalkanes, urea derivatives, oxygen and nitrogen acetals and formals, benzamidines, isothiazoles and their derivatives such as isothiazolines and isothiazolinones, phthalimide derivatives, pyridine derivatives, antimicrobial surface-active compounds, guanidines, antimicrobial amphoteric compounds, quinolines, 1,2-dibromo-2,4-dicyanobutane, iodo-2-propynyl butyl carbamate, iodine, iodophores and peroxides. Among these, preferred active substances are preferably selected from the group that includes 1,3-butane diol, phenoxyethanol, 1,2-propylene glycol, glycerin, undecylenic acid, citric acid, lactic acid, benzoic acid, salicylic acid, thymol, 2-benzyl-4-chlorophenol, 2,2′-methylene-bis-(6-bromo-4-chlorophenol), 2,4,4′-trichloro-2′-hydroxydiphenyl ether, N-(4-chlorophenyl)-N-(3,4-dichlorophenyl)-urea, N,N′-(1,10-decanediyldi-1-pyridinyl-4-ylidene)-bis-(1-octanamine)dihydrochloride, N,N′-bis-(4-chlorophenyl)-3,12-diimino-2,4,11,13-tetraazatetradecanediimide amide, quaternary surface active compounds, guanidine. Preferred surface active quaternary compounds comprise an ammonium, sulfonium, phosphonium, iodonium or arsonium group. Furthermore, disinfecting ethereal oils can also be incorporated and provide a fragrance to the virucidal treatment solution. However, particularly preferred active substances are selected from the group comprising salicylic acid, quaternary surfactants, especially benzalkonium chloride, peroxy compounds, especially hydrogen peroxide, alkali metal hypochlorite as well as mixtures thereof. Such an additional disinfecting ingredient is comprised for example in an amount of 0.01 to 1 wt %, preferably 0.02 to 0.8 wt %, particularly 0.05 to 0.5 wt %, particularly preferably 0.1 to 0.3 wt %, most preferably 0.2 wt % in the surfactant preparation.

Liquid surfactant preparations according to the invention which are in the form of solutions in standard solvents are generally prepared by a simple mixing of the ingredients, which can be added as is or as a solution into an automatic mixer.

Surfactant preparations according to the invention can exclusively comprise a lipase as described as the enzymatic component. Alternatively, they can also comprise additional hydrolytic enzymes or other enzymes in a concentration that is appropriate for the activity of the surfactant preparation. In another embodiment of the invention, the surfactant preparation thus contains at least one additional enzyme. In principle in this regard, all enzymes that are established in the prior art for these purposes can be incorporated. All enzymes that can develop a catalytic activity in a surfactant preparation according to the invention can preferably be incorporated as the additional enzymes, in particular a protease, amylase, cellulase, hemicellulase, mannanase, pectinase, tannase, xylanase, xanthanase, β-glucosidase, carrageenase, perhydrolase, oxidase, oxidoreductase or an additional lipase, as well as their mixtures. Additional enzymes are each advantageously comprised in the surfactant preparation in a total amount of 1×10⁻⁸ to 5 wt % based on the active protein. Each additional enzyme is comprised with increasing preference in surfactant preparations according to the invention in an amount of 1×10⁻⁷ to 3 wt %, 0.00001-1 wt %, 0.00005-0.5 wt %, 0.0001 to 0.1 wt % and particularly preferably 0.0001 to 0.054 wt %, based on active protein. The enzymes particularly preferably exhibit synergistic cleaning powers towards certain soils or stains, i.e. the enzymes comprised in the surfactant preparation mutually support each other in their cleaning power. Such a synergy is quite particularly present between the lipase and an additional enzyme comprised in the surfactant preparation according to the invention, including in particular between the lipase and a protease and/or an amylase and/or a mannanase and/or a cellulase and/or a pectinase. Synergistic effects can not only appear between various enzymes but also between one or more enzymes and additional ingredients of the surfactant preparation according to the invention.

Preferred proteases are those of the subtilisin type. Examples of these are the subtilisins BPN′ and Carlsberg, the protease PB92, the subtilisins 147 and 309, the alkaline protease from Bacillus lentus, subtilisin DY and those enzymes of the subtilases no longer however classified in the stricter sense as subtilisins: thermitase, proteinase K and the proteases TW3 and TW7. Subtilisin Carlsberg in further developed form is available under the trade name Alcalase® from Novozymes A/S, Bagsværd, Denmark. Subtilisins 147 and 309 are commercialized under the trade names Esperase® and Savinase® by the Novozymes Company. The protease variants sold under the name BLAP® are derived from the protease from Bacillus lentus DSM 5483. Further useable proteases are, for example, the enzymes available with the trade names Durazym®, Relase®, Everlase®, Nafizym®, Natalase®, Kannase® and Ovozyme® from the Novozymes Company, those under the trade names Purafect®, Purafect® 0xP, Purafect® Prime, Excellase® and Properase® from Genencor, that under the trade name Protosol® from Advanced Biochemicals Ltd., Thane, India, that under the trade name Wuxi® from Wuxi Snyder Bioproducts Ltd., China, those under the trade names Proleather® and Protease P® from Amano Pharmaceuticals Ltd., Nagoya, Japan, and that under the designation Proteinase K-16 from Kao Corp., Tokyo, Japan. The proteases from Bacillus gibsonii and Bacillus pumilus which are disclosed in the international patent applications WO2008/086916 and WO2007/131656, are particularly preferably employed.

Examples of conditionable amylases according to the invention are the α-amylases from Bacillus licheniformis, from B. amyloliquefaciens or from Bacillus stearothermophilus, as well as their improved further developments for use in washing or cleaning agents. The enzyme from Bacillus licheniformis is available from the Novozymes Company under the name Termamyl® and from the Danisco/Genencor Company under the name Purastar®ST. Further development products of this α-amylase are available from the Novozymes Company under the trade names Duramyl® and Termamyl®ultra, from the Danisco/Genencor Company under the name Purastar®OxAm and from Daiwa Seiko Inc., Tokyo, Japan as Keistase®. The α-amylase from Bacillus amyloliquefaciens is commercialized by the Novozymes Company under the name BAN®, and derived variants from the α-amylase from Bacillus stearothermophilus under the names BSG® and Novamyl® also from the Novozymes Company. Moreover, for this purpose, attention should be drawn to the α-amylase from Bacillus sp. A 7-7 (DSM 12368) and the cyclodextrin-glucanotransferase (CGTase) from Bacillus agaradherens (DSM 9948). Fusion products of all the cited molecules can also be used. Moreover, further developments of α-amylase from Aspergillus niger and A. oryzae available from the Company Novozymes under the trade name Fungamyl® are suitable. Additional commercial products that can be advantageously used are for example the Amylase-LT® and Stainzyme® or Stainzyme Ultra® or Stainzyme Plus®, the last also from the Novozymes company. Variants of these enzymes obtained by point mutations can also be inventively incorporated. Particularly preferred amylases are disclosed in the international applications WO 00/60060, WO 03/002711, WO 03/054177 and WO 07/079,938, to which disclosures reference is therefore expressly made or in this regard their disclosed content is therefore expressly incorporated into the present patent application. Inventively conditionable amylases are moreover preferably α-amylases.

Exemplary additional inventively conditionable lipases or cutinases that are comprised in particular due to their triglyceride-cleaving activities, but also to generate peracids in situ from appropriate precursors, are the lipases that are originally obtainable from Humicola lanuginose (Thermomyces lanuginosus) or further developed lipases, especially those with the amino acid exchange D96L. They are commercialized, for example by the Novozymes Company under the trade names Lipolase®, Lipolase® Ultra, LipoPrime®, Lipozyme® and Lipex®. Moreover, suitable cutinases, for example are those that were originally isolated from Fusarium solani pisi and Humicola insolens. Suitable lipases or cutinases whose starting enzymes were originally isolated from Pseudomonas mendocina and Fusarium solanii are for example available from Genencor Company. Further important commercial products that may be mentioned are the commercial preparations M1 Lipase® and Lipomax® originally from Gist-Brocades Company, and the commercial enzymes from the Meito Sangyo KK Company, Japan under the names Lipase MY-30®, Lipase OF® and Lipase PL® as well as the product Lumafast® from the Genencor Company.

Washing or cleaning agents according to the invention can further comprise cellulases, depending on the purpose, as pure enzymes, as enzyme preparations or in the form of mixtures, in which the individual components advantageously complement each other in regard to their various performance aspects. Among these aspects of performance are particular contributions to primary washing performance, to secondary washing performance of the product, (anti-redeposition activity or inhibition of graying) and softening or brightening (effect on the textile), through to practicing a “stone washed” effect.

Inventively conditionable cellulases (endoglucanases, EG) include for example the fungal, endoglucanase (EG)-rich cellulase preparation or its further developments that are offered by the Novozymes Company under the trade name Celluzyme®. The products Endolase® and Carezyme® based on the 50 kD-EG, respectively 43 kD-EG from Humicola insolens DSM 1800 are also obtainable from the Novozymes Company. Further useable commercial products from this company are Cellusoft®, Renozyme® and Celluclean®. Cellulases, for example, which are available under the trade names Ecostone® and Biotouch® from AB Enzymes, Finland can also be used and which are at least partially based on the 20 kD-EG from Melanocarpus. Additional cellulases from the AB Enzymes Company are Econase® and Ecopulp®. Further suitable cellulases are from Bacillus sp. CBS 670.93 and CBS 669.93, the CBS 670.93 from Bacillus sp. being available under the trade name Puradax® from the Danisco/Genencor Company. Additional useable commercial products of the Danisco/Genencor Company are “Genencor detergent cellulase L” and lndiAge®Neutra.

Variants of these enzymes obtained by point mutations can also be inventively incorporated. Particularly preferred cellulases are Thielavia terrestris cellulase variants, which are disclosed in the international application WO 98/12307, cellulases from Melanocarpus, in particular Melanocarpus albomyces, which are disclosed in the international application WO 97/14804, cellulases of the EGIII type from Trichoderma reesei, which are disclosed in the European patent application EP 1 305 432 or variants that can be obtained from them, in particular those that are disclosed in the European patent applications EP 1240525 and EP 1305432, as well as cellulases, which are disclosed in the international patent applications WO 1992006165, 96/29397 and WO 02/099091. Reference is therefore expressly made to their respective disclosure or their disclosed content in this regard is therefore expressly incorporated into the present patent application.

Additional enzymes, which are summarized under the term hemicellulases, can also be incorporated, especially for removing specific problematic soils. These additional enzymes include, for example mannanases, xanthanlyases, pectinlyases (=pectinases), pectinesterases, pectatlyases, xyloglucanases, xylanases, pullulanases and β-glucanases. In this regard, suitable enzymes are for example available under the names Gamanase® and Pektinex AR® from the Novozymes Company, under the names Rohapec® B1L L from AB Enzymes and under the names Pyrolase® from Diversa Corp., San Diego, Calif., USA. β-Glucanase, extracted from Bacillus subtilis, is available under the name Cereflo® from the Novozymes Company. Hemicellulases that are inventively particularly preferred are mannanases, e.g. those that are marketed for example under the trade names Mannaway® from the Novozymes Company or Purabrite® from the Genencor Company.

To increase the bleaching action, a surfactant preparation according to the invention can also comprise oxidoreductases, for example oxidases, oxygenases, catalases (that react at lower H₂O₂ concentrations than peroxidase), peroxidases, like halo-, chloro-, bromo-, lignin-, glucose- or manganese-peroxidases, dioxygenases or laccases (phenoloxidases, polyphenoloxidases). Suitable commercial products are Denilite® 1 and 2 from the Novozymes Company. For an advantageously employable exemplary system for an enzymatic perhydrolysis, reference may be made to the applications WO 98/45398 A1, WO 2005/056782 A2 and WO 2004/058961 A1. A combined enzymatic bleach system, containing an oxidase and a perhydrolase, is described in the application WO 2005/124012. Additional, preferably organic, particularly preferably aromatic compounds are advantageously added that interact with the enzymes to enhance the activity of the oxidoreductases in question (enhancers) or to facilitate the electron flow (mediators) between the oxidizing enzymes and the soils over strongly different redox potentials.

The inventively employable enzymes can also be conditioned together with concomitant substances, for example from the fermentation, or with stabilizers and be incorporated in a conditioned form of this type into a surfactant preparation according to the invention.

Another subject matter of the invention is represented by the use of a surfactant preparation according to the invention for removing soils, in particular lipase-sensitive soils, on fabrics or hard surfaces, i.e. for cleaning fabrics or hard surfaces. Due in particular to the comprised combination of phosphonate and lipase, the surfactant preparations according to the invention can be advantageously used for this purpose in order to eliminate corresponding contamination from fabrics or from hard surfaces. Washing by hand, the manual removal of stains from fabrics or from hard surfaces or the use in connection with an automatic process are exemplary embodiments of this subject matter of the invention. All facts, subject matters and embodiments, which have been described for surfactant preparations according to the invention, are also applicable to this subject matter of the invention. Therefore, reference is hereby explicitly made to the disclosure at the appropriate location with the remark that this disclosure is also valid for the preceding use according to the invention. This correspondingly applies for the use of a surfactant preparation according to the invention for disinfection.

Another subject matter is represented by a method for cleaning fabrics or hard surfaces or for disinfection, wherein a surfactant preparation according to the invention is used in at least one process step.

Another subject matter of the invention is a method, in particular a washing, cleaning or disinfection method, in which a washing liquor that contains a phosphonate and a lipase that exists naturally in a microorganism, is brought into contact with a lipase-sensitive soil or a germ on a fabric or on a hard surface, wherein said microorganism is Rhizopus oryzae or Mucor javanicus.

These methods include both manual as well as automatic methods, automatic methods being preferred due to their more precise controllability in regard to, for example, the added quantities and contact times. Methods for cleaning fabrics are generally characterized in that one or more cleaning-active substances are applied to the material to be cleaned and, after the contact time, are washed away. In particular, the material to be treated with the surfactant preparation or with the washing liquor formed with it, is preferably treated for a certain minimum period, for example 5, 10, 15, 20, 25, 30, 40, 50 or 60 minutes. The same is true for methods for cleaning all materials other than fabrics, especially hard surfaces. In disinfection methods, the germ to be killed off is brought into contact with the surfactant preparation or with the washing liquor formed with it, preferably for a certain minimum period, for example 5, 10, 15, 20, 25, 30, 40, 50 or 60 minutes. All conceivable washing cleaning or disinfecting methods can be enhanced in at least one of the process steps with the use of a surfactant preparation according to the invention or with the use of a lipase according to the invention in combination with a phosphonate and then represent embodiments of the present invention. All facts, subject matters and embodiments, which have been described for surfactant preparations according to the invention, are also applicable to these subject matters of the invention. Therefore, reference is hereby explicitly made to the disclosure at the appropriate location with the remark that this disclosure is also valid for the preceding method according to the invention.

In a preferred embodiment, a method according to the invention is wherein the lipase is present in the washing liquor in a concentration of 0.0000003 to 0.0004 wt %, preferably 0.0000005 to 0.0003 wt %, wherein the data are based on active protein in the washing liquor. In another preferred embodiment, a method according to the invention is wherein it is carried out at a temperature between 10° C. and 80° C., preferably between 10° C. and 70° C. and particularly preferably between 20° C. and 60° C.

Inventively provided lipases are advantageously employable in surfactant preparations according to the invention as well as methods, in particular washing, cleaning or disinfecting methods. They can also be advantageously used in order to provide a lipolytic activity in corresponding preparations.

Another subject matter of the invention is consequently represented by the use of a lipase that exists naturally in a microorganism, wherein the microorganism is Rhizopus oryzae or Mucor javanicus, so as to provide lipolytic activity in a liquid surfactant preparation that additionally contains a phosphonate.

Another subject matter of the invention is the use of a lipase that exists naturally in a microorganism, wherein the microorganism is Rhizopus oryzae or Mucor javanicus, so as to remove lipase-sensitive soils on fabrics or hard surfaces or for disinfection in a washing liquor that additionally contains a phosphonate.

All facts, subject matters and embodiments, which have been described for surfactant preparations according to the invention and/or inventive methods, are also applicable to the cited uses. Therefore, reference is hereby explicitly made to the disclosure at the appropriate location with the remark that this disclosure is also valid for the preceding uses according to the invention.

### Example

Determination of the cleaning power of a liquid surfactant preparation according to the invention

In this example standardized soiled fabrics were employed which had been obtained from the Center For Testmaterials (CFT, Vlaardingen, Netherlands). The following soils and fabrics were used:

A: carbon black/mineral oil on cotton: product no. C-01 available from CFT;
B: carbon black/olive oil on cotton: product no. C-02 available from CFT;
C: pigment/oil on cotton: product no. C-09 available from CFT;
D: sebum/carbon black on cotton: product no. C-S-32 available from CFT.

The cleaning power of various washing agents was investigated with this test material. For this the sample materials were washed for 30 minutes at temperatures of 40° C. The washing agent was used at a concentration of 3.5 g per liter washing liquor. Mains water with a hardness of about 16° German hardness was used for washing.

A basic washing agent formulation was used as the control and had the following composition (all amounts in weight percent): 0.3-0.5% xanthan gum, 0.2-0.4% defoamer, 6-7% glycerin, 0.3-0.5% ethanol, 4-7% FAEOS (fatty alcohol ether sulfate), 24-28% non-ionic surfactants, 1% boric acid, 1-2% sodium citrate (dihydrate), 2-4% soda, 14-16% cocoanut fatty acids, 0.5% HEDP (1-hydroxyethane-1,1-diphosphonic acid), 0-0.4% PVP (polyvinyl pyrrolidone), 0-0.05% optical brightener, 0-0.001% colorant, remainder demineralized water.

For the various test series, the following lipases were added to this basic washing agent preparation at identical activity to 0.35 wt % Lipex 100L (lipase preparation from Novozymes Company (mixture 4 as the reference)): Lipase M-AP10® (mixture 1), Lipase LE® (mixture 2) and Lipase F® (also Lipase JV®; mixture 3), all available from Amano Pharmaceuticals.

After washing, the whiteness degree of the washed fabrics was measured. The measurement was made with a spectrometer Minolta CM508d (light type D65, 10°). The apparatus was calibrated beforehand with a white standard delivered with the apparatus. The obtained results are the diffuse reflectance differences between a wash cycle with a washing agent comprising the relevant lipase and a control cycle carried out in parallel with a washing agent without lipase. The results are summarized in the following Table 1 and enable a direct conclusion to be drawn on the contribution of each of the comprised enzymes to the cleaning power of the used agent.

TABLE 1
Washing results with a liquid washing agent at 40° C.

| Soil | Mix 1 | Mix 2 | Mix 3 | Mix 4 |
|---|---|---|---|---|
| A | 32.6 | 32.2 | 33.3 | 29.7 |
| B | 32.1 | 31.9 | 32.1 | 27.1 |
| C | 63.2 | 61.9 | 62.1 | 61.2 |
| D | 31.6 | 31.8 | 32.8 | 30.8 |

It is clear that inventive surfactant preparations (mixtures 1 to 3) show good cleaning powers that are superior to the reference (mixture 4).

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A liquid surfactant preparation containing a phosphonate and a lipase that exists naturally in a microorganism, wherein the microorganism is Rhizopus oryzae or Mucor javanicus.

2. The surfactant preparation according to claim 1, wherein the phosphonate is selected from the group consisting of 1-hydroxyethane-1,1-diphosphonic acid (HEDP), aminotrimethylene phosphonic acid (ATMP), nitrilotrimethylene phosphonic acid (NTMP), diethylenetriaminepentamethylene phosphonic acid (DTPMP, DETPMP or DTPNT), ethylenediaminetetramethylene phosphonic acid (EDTMP), 2-phosphonobutane-1,2,4-tricarboxylic acid (PBS-AM) and combinations thereof.

3. The surfactant preparation according to claim 1, wherein the lipase possesses an amino acid sequence that is at least 80% identical to the amino acid sequence listed in SEQ ID NO. 1.

4. The surfactant preparation according to claim 1, wherein the phosphonate is included in an amount of 0.01 to 4 wt %, and the lipase is comprised in an amount of 1×10⁻⁸ to 5 wt %, based on active protein.

5. The surfactant preparation according to claim 1, wherein the surfactant preparation is a preparation selected from the group consisting of a washing agent, cleaning agent and a disinfectant.

6. The surfactant preparation according to claim 1, further comprising one or more components selected from the group consisting of:
i. an anionic and/or polyanionic substance,
ii. a cationic and/or polycationic substance, and
iii. a substance that possesses hydroxyl and/or polyhydroxyl group(s).

7. The surfactant preparation according to claim 1, wherein the surfactant preparation further comprises at least one additional ingredient selected from the group consisting of builder, peroxygen compound, bleach activator, non-aqueous solvent, acid, water-soluble salt, thickener, disinfecting ingredient and combinations thereof, and further comprises at least one additional enzyme selected from the group consisting of a protease, amylase, cellulase, hemicellulase, mannanase, pectinase, tannase, xylanase, xanthanase, β-glucosidase, carrageenase, perhydrolase, oxidase, oxidoreductase a lipase, and their mixtures thereof.

8. A method for cleaning fabric or a hard surface or for disinfection, comprising contacting the fabric or hard surface with the surfactant preparation according to claim 1.

9. A washing, cleaning or disinfection method, comprising bringing a washing liquor that comprises a phosphonate and a lipase that exists naturally in a microorganism into contact with a lipase-sensitive soil or a germ on a fabric or on a hard surface, wherein said microorganism is Rhizopus oryzae or Mucor javanicus.
